(19) United States
(12) Patent Application Publication
(10) Pub. No.: US 2005/0197601 A1
(43) Pub. Date: Sep. 8, 2005

(54) Sole massage device

(76) Inventor: Hideo Kimpara, Hamakita-shi (JP)

Correspondence Address: LORUSSO, LOUD & KELLY, 3137 Mt. Vernon Avenue, Alexandria, VA, 22305, US

(21) Appl. No.: 10/938,947

(22) Filed: Sep. 13, 2004

(30) Foreign Application Priority Data
Mar. 8, 2004 (JP) 2004-63732
May 21, 2004 (JP) 2004-151138

(51) Int. Cl. A61H 15/00; A61H 7/00

(52) U.S. Cl. 601/118; 601/122; 601/128; 601/131

(57) ABSTRACT

A sole massage device includes a base that extends generally horizontally. A pair of posts extend upward from the base. A roller is rotatably supported by the posts above the base. In one embodiment, a pair of massage units having the base, the posts and the roller are coupled with each other to form a set of sole massage device.

### PRIORITY INFORMATION

This application is based on and claims priority to Japanese Patent Applications No. 2004-63732, filed Mar. 8, 2004 and No. 2004-151138, filed May 21, 2004, the entire contents of which are hereby expressly incorporated by reference.

### BACKGROUND OF THE INVENTION

1. Field of the Invention

The present invention generally relates to a sole massage device, and more particularly relates to an improved sole massage device that can make a rubdown of a sole.

2. Description of Related Art

Sole massage device are useful to take the stiffness out of a sole or to improve the circulation of the blood. For example, a sole massage device that is well known has a plurality of projections extending upward from a base plate. The projections are planted in limited areas corresponding to the human soles of the right and left feet The projections can stimulate target spots of the user's soles when the user steps on the areas of the plate. The massage device, however, requires the user to put his or her whole weight onto the projections. Also, the user should accurately put the target spots on associated projections to effectively massage those spots. Thus, it is difficult to use the device while sitting on a chair or seat. Besides, the massage device is bulky and is not convenient to carry. Japanese patent publications Nos. 2003-290314 and 2003-339813 disclose improved sole massage devices.

The massage device disclosed in patent publication No. 2003-290314 is somewhat improved so that the user can use the device while sitting on a chair or seat. The massage device also is smaller than the device noted above. However, this massage device does not allow the user to put target spots of the soles onto associated projections. Also, the massage device requires the user to carry at least one set of units corresponding to the soles of the right and left feet.

The device disclosed in patent publication No. 2003-339813 has a pair of cranks which are shifted 180 degrees in phase from one another. A roller is journaled on each crank. The device also has an arm elongated upward from a bearing portion of the cranks. A top end of the arm is provided with a pair of grips such that a user of the device can hold. The user thus can massage his or her soles with the rollers while sitting on a chair or seat and holds the grips. The rollers, however, can massage only some limited spots where the rollers touch when the user rotates the cranks. Thus, much effect can not be expected. The massage device also is bulky because of the elongated arm and two cranks. In addition, the cranks require a relatively large space to rotate.

### SUMMARY OF THE INVENTION

An aspect of the present invention involves the recognition of the need for an improved sole massage device that can be easily used to massage specific spots of the sole and can be small enough to carry.

To address one or more of such needs, an aspect of the present invention involves a sole massage device that comprises a roller adapted to contact a sole. A base is arranged to rotatably support the roller.

In accordance with another aspect of the present invention, a sole massage device comprises first and second rollers each adapted to contact each sole of a human body. A base is arranged to rotatably support the rollers.

In accordance with a further aspect of the present invention, a sole massage device comprises a rotary member having a plurality of projections on a surface thereof. A support member is arranged to support the rotary member. A horizontal member extends generally horizontally. The support member extends upward from the horizontal member.

### BRIEF DESCRIPTION OF THE DRAWINGS

These and other features, aspects and advantages of the present invention are now described with reference to the drawings of preferred embodiments, which embodiments are intended to illustrate and not to limit the present invention. The drawings comprise thirteen figures in which:

FIG. 1 illustrates a front elevation view of a sole massage device configured in accordance with a preferred embodiment and advantages of the present invention, wherein user's feet are shown in phantom;

FIG. 2 illustrates a top plan view of the sole massage device of FIG. 1, wherein user's feet are also shown in phantom;

FIG. 3 illustrates a side elevation view of a roller of the sole massage device;

FIG. 4 illustrates a front elevation view of the roller of FIG. 4;

FIG. 5 illustrates a cross-sectional view of the roller taken along the lines 5-5 of FIG. 3;

FIG. 6 illustrates a front sectional view of one section of a modified sole massage device configured in accordance with a second embodiment and advantages of the present invention;

FIG. 7 illustrates a top plan view of the section of the massage device of FIG. 6, wherein the section is partially shown in cross-section;

FIG. 8 partially illustrates an enlarged cross-sectional view of the section of the massage device;

FIG. 9 illustrates a top plan view showing two sections of the massage device coupled with each other;

FIG. 10 illustrates a front elevation view of a further modified sole massage device configured in accordance with a third embodiment and advantages of the present invention;

FIG. 11 illustrates a top plan view of the sole massage device of FIG. 10;

FIG. 12 illustrates a front sectional view of a further modified sole massage device configured in accordance with a fourth embodiment and advantages of the present invention; and

FIG. 13 illustrates a top plan view of the sole massage device of FIG. 12.

### DETAILED DESCRIPTION OF PREFERRED EMBODIMENTS OF THE PRESENT INVENTION

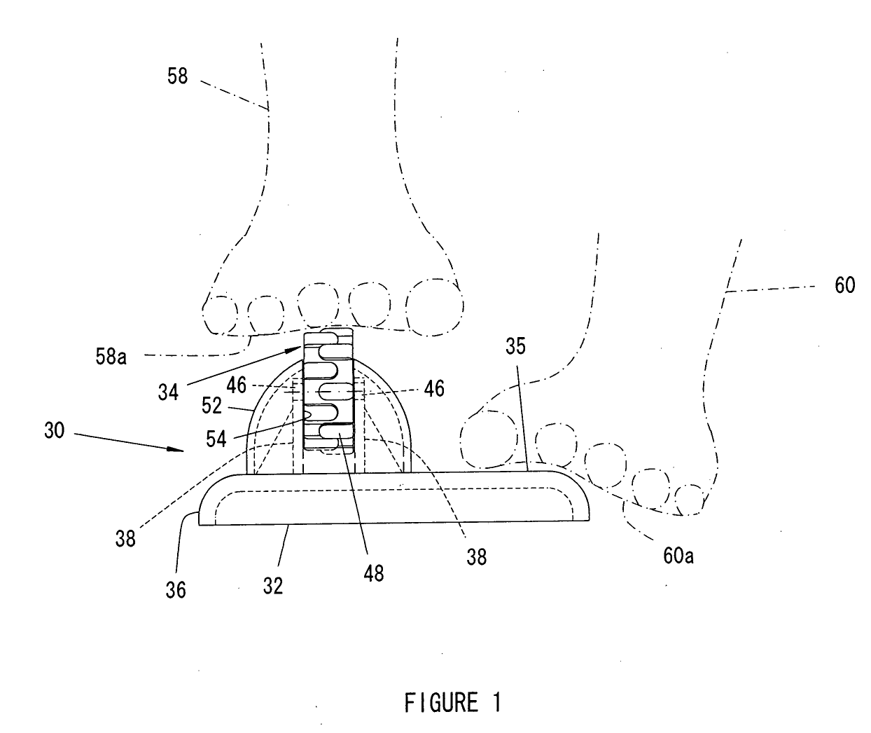

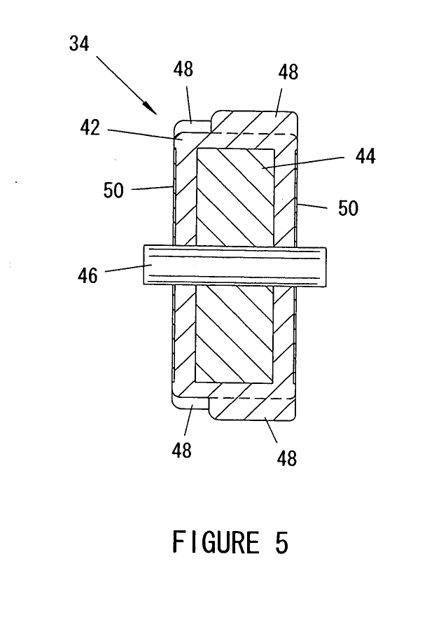

With reference to FIGS. 1-5, a preferred sole massage device 30 comprises a base 32 and a roller 34. The base 32 rotatably supports the roller 34.

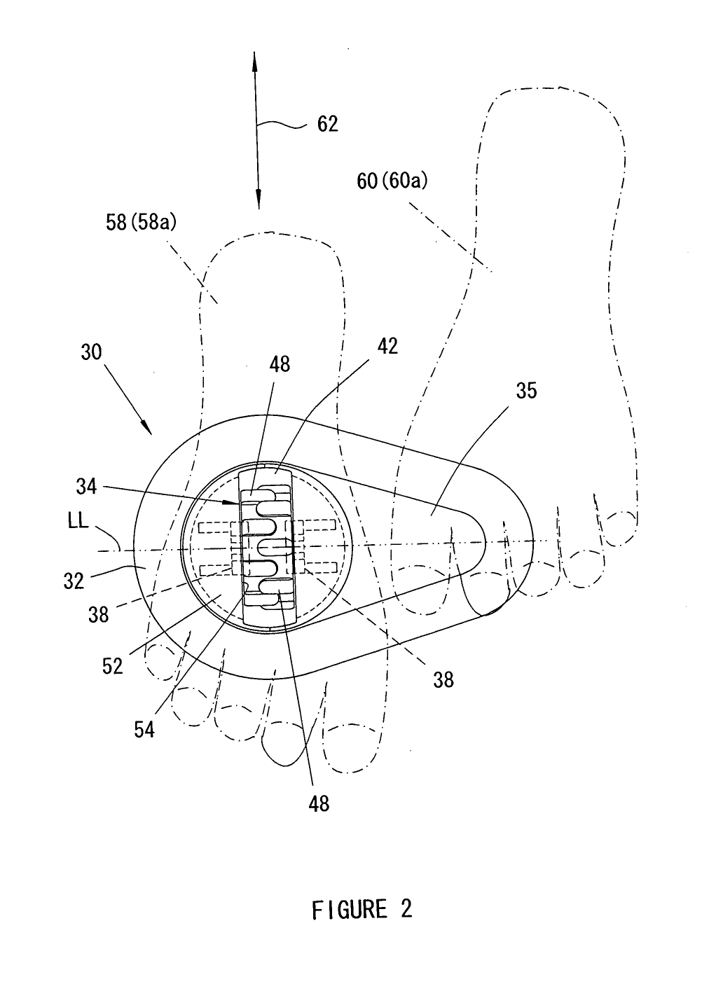

The base 32 preferably comprises a horizontally extending portion 36 and a pair of posts 38. The base 32 in the illustrated embodiment is made of plastic and is generally ovally configured as shown in FIG. 2. That is, one large area and one small area are juxtaposed along a longitudinal line LL of the base 32 to form the configuration in the top plan view. The small area defines a protruded portion 35. Preferably, a longitudinal length is approximately 120 millimeters, a radius of a large circle that generally defines the large area is approximately 40 millimeters and a radius of a small circle that defines the small area. A peripheral portion of the base 32 preferably is sloped down toward an edge so that a central portion has a certain height.

The posts 38 extend upward from a top surface of the base 32 in the large area. Preferably, the posts 38 are unitarily formed with the base 32. In one variation, the posts 38 can be formed separately from the base 32 and can be coupled with the base 32. The illustrated posts 38 are rectangularly shaped and oppose each other on the longitudinal line LL. Each post 38 preferably is disposed normal to the longitudinal line LL.

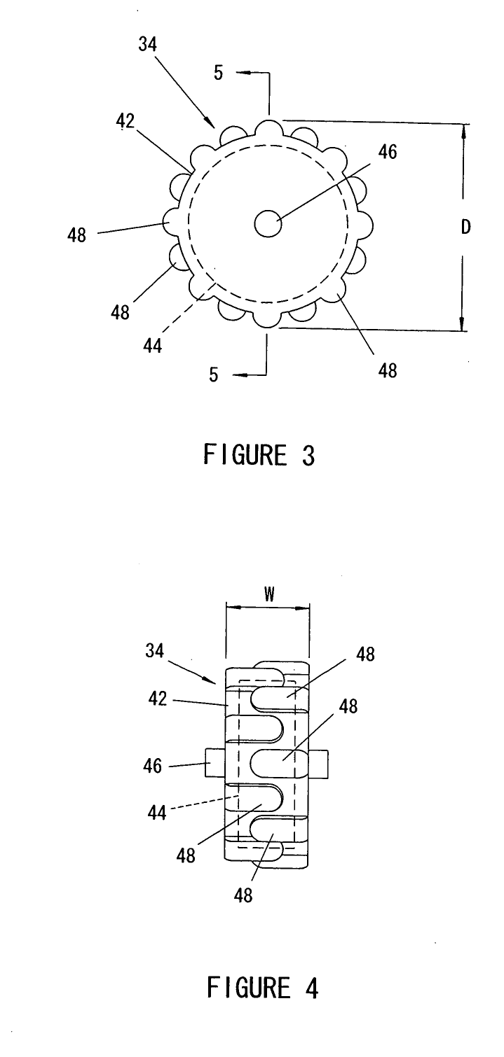

As shown in FIGS. 3-5, the roller 34 preferably comprises a roller body 42, magnet 44 and a shaft 46. The roller body 42 encloses the magnet 44. The shaft 46 extends through the roller body 42 and the magnet 44. In the illustrated embodiment, the posts 38 journal the shaft 46 so that the roller 34 can rotate above the base 32.

The illustrated roller body 42 has a cylindrical configuration and is made of plastic or hard rubber. The roller body 42 preferably is sized smaller than an ordinary human sole. For example, a width W (a length along the longitudinal line LL) of the roller body 42 is approximately 15 millimeters and a diameter D thereof is 38 millimeters. The illustrated roller body 42 has sixteen projections 48 on the circumferential surface. The projections 48 are disposed circumferentially at regular intervals. Each projection 48 is elongated axially toward a center line on the circumferential surface from an edge of the surface. The projections 48 preferably are elongated alternately from different edges so that one projection 48 is nested between two other projections 48 disposed next to the one projection 48. A cross section of each projection 48 preferably is a semicircle. Alternatively, studded cones, hemispheres or any other shaped projections can replace the semicircle projections. Irregular arrangements of the projections on the circumferential surface also are applicable.

The magnet 44 has a relatively thick disk shape and is sized smaller than the roller body 42. The roller body 42 in the illustrated embodiment entirely surrounds the magnet 44 that is disposed coaxially. Magnetic poles of the magnet 44 are disposed circumferentially. In other words, south poles and north poles appear alternately along a circumferential surface of the magnet 44. The maximum magnetic-flux density of the magnet 44 that radiates from the circumferential surface preferably is approximately 140 mT (milli-tesla). In the illustrated embodiment, a metallic side plate 50 is affixed to each side of the roller body 42. The side plates 50 inhibit lines of magnetic force from leaking from the side surfaces of the roller body 42.

The shaft 46 extends through each center of the roller body 42, the magnet 44 and the side plates 50. A distal end of the shaft 46 protrudes from each side surface of the roller body 42. Each post 38 journals each distal end of the shaft 46. In the illustrated embodiment, the shaft 46 is made of metal and is press-fitted into the roller body 42 and the magnet 44.

In the illustrated embodiment, a cover member 52 is attached to the base 32 to cover the posts 38 and a large part of the roller 34 except for a top portion of the roller 34. The cover member 52 can be made of plastic or metal and is detachably affixed to the top surface of the base 32. Preferably, multiple coupling ends extend from a bottom end of the cover member 52. The coupling ends are fitted into slits or holes formed at corresponding portions of the base 32 such that the cover member 52 is affixed to the base 32. A center portion of the cover member 52 has a relatively large slot or opening 54 that extends generally normal to the longitudinal line LL. The top portion of the roller 34 extends through the slot 54. Thus, the top portion is exposed out of the cover member 52.

A user who wants to use the sole massage device 30 sits down to a suitable chair or seat and puts the sole massage device 30 on the floor such that the longitudinal line LL extends parallel to the user. The user steps on the small area of the base 32, i.e., the protruded portion 35, to securely place the device 30 on the floor. For instance, if the user wants to massage the sole 58a of his or her right foot 58, the user steps on the protruded portion 35 by the left foot 60. The user, then, softly put his or her right foot 58 onto the roller 34 such that a target spot of the sole 60 of this foot 60 contacts a portion of the circumferential surface that is positioned atop of the roller 34 at this moment. The target spots include portions of the sole 58a, 60a which needs to be rubbed down, such as, for example, the arch of the foot.

Then, the user moves the right foot 58 back and forth as indicated by the arrow 62 of FIG. 2. With this movement, the roller 34 rotates and the projections 48 rub down the target spot of the sole 58a. Thus, the stiffness can be effectively taken out of the sole 58a and/or the circulation of the blood can be improved. In addition, the magnetic force of the magnet 44 can expedite the effect.

The user can massage the sole 60a of the left foot 60 in a similar manner. That is, the user turns the massage device 30 to place the small area of the base 32 in front of the right foot 58 and then repeats the same steps as those described above.

As thus described, the massage device 30 can easily massage target or specific spots. The massage device 30 does not require the user to put his or her whole weight thereto. The user thus can use the massage device 30 while sitting on a chair or seat of a vehicle (i.e., airplane, bus or vessel). Because the massage device 30 only needs a space for the roller 34 to rotate, the device 30 is compact enough to be placed in a suitcase or a dress pocket. Thus, the user can easily carry the device 30 while traveling. Also, the user is only required to carry at least one massage device 30 because the device 30 can be used irrespective of the right or left foot.

In addition, the multiple projections 48 can stimulate the soles to expedite the massage effect. Also, the magnetic force that is radiated from the magnet 44 can further improve the massage effect.

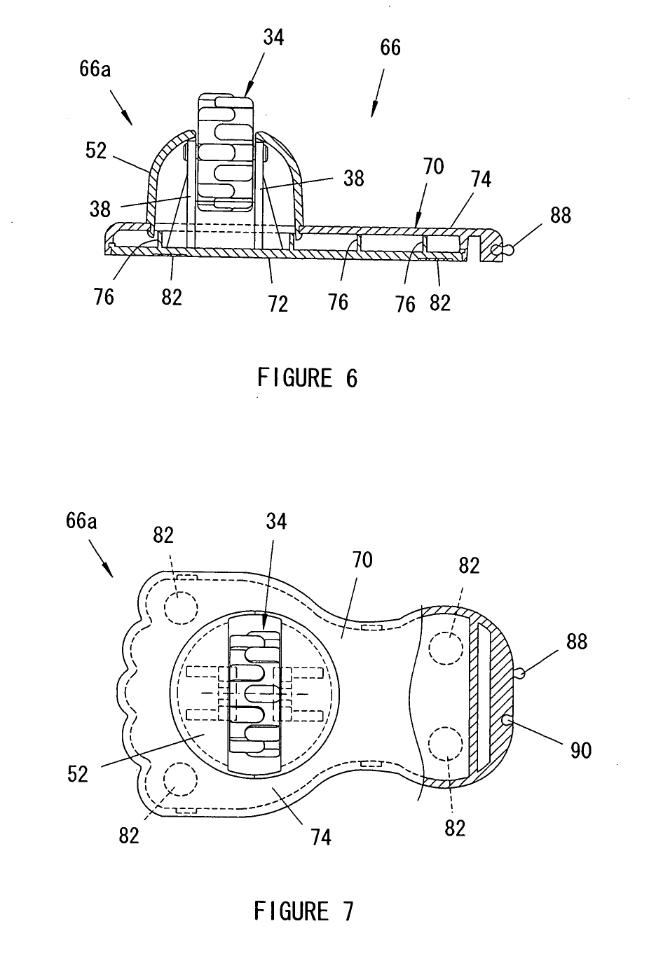

With reference to FIGS. 6-9, another sole massage device 66 modified in accordance with a second embodiment of the present invention is described. The modified massage device 66 comprises a pair of massage units 66a, 66b. Each massage unit 66a, 66b is similar to the sole massage device 30. In this embodiment, those massage units 66a, 66b are detachably coupled with each other when the user uses the massage device 66. Because each unit 66a, 66b is similar to the sole massage device 30 described above, the same members and components are assigned with the same reference numerals and are not described repeatedly.

A base section 70 of each unit 66a, 66b preferably comprises a bottom member 72 and a top member 74. The bottom and top members 72, 74 are made of plastic or metal. Each member 72, 74 is shaped like a human sole in this embodiment. The members 72, 74, however, can have various configurations such as, for example, an oval shape or rectangular shape. Both of the members 72, 74 are coupled with each other in a suitable manner to be the unitary base section 70. A plurality of ribs 76 extends upward toward the top member 74 to reinforce the base section 70.

The top member 74 has a relatively large opening. The posts 38 extend through the opening from the bottom member 72. Each post 38 in this embodiment has a rib 80 to rigidly support the post 38. The cover member 52 is affixed to an inner edge of the top member 74 that forms the opening.

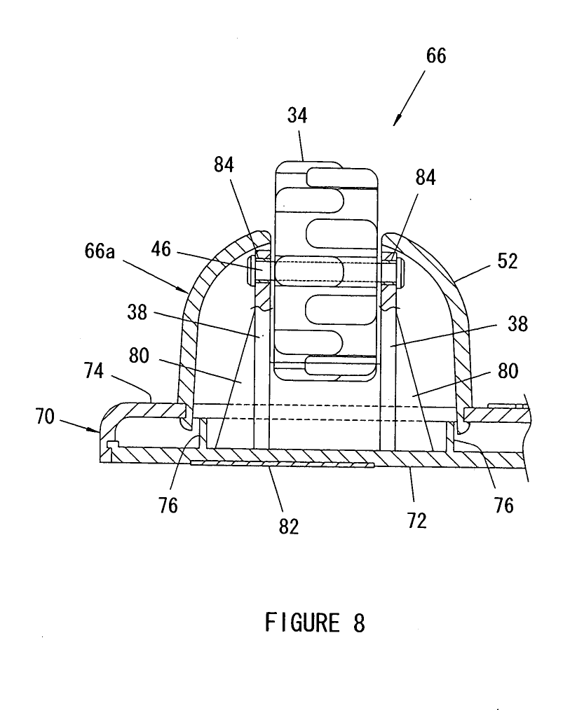

FIG. 8 shows that each post 38 journals the shaft 46 with a plain bearing 84. The sole massage device 30 described above also uses plain bearings, although the bearings are not shown. Of course, other bearings such as, for example, ball bearings can be used in the massage units 66a, 66b and also in the massage device 30.

Circular slippage stoppers 82 are attached to a bottom surface of the bottom member 72 to prevent the base section 70 from slipping. The stoppers 82 preferably are made of rubber. In the illustrated embodiment, four slippage stoppers 82 are attached to four corners of the bottom member 72.

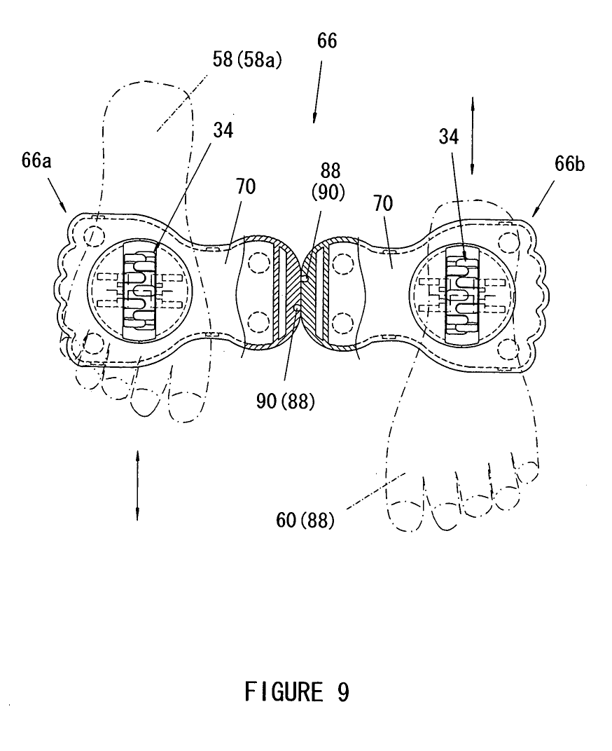

Each massage unit 66a, 66b preferably has one engage projection 88 and one engage recess 90. The projection 88 and the recess 90 are positioned on a side surface opposite to the rollers 34. As shown in FIG. 9, the projection 88 of the massage unit 66a can engage the recess 90 of the massage unit 66b and vice versa when both the massage units 66a, 66b are placed back to back with each other. More specifically, the projection 88 and the associated recess 90 have the same configuration such that each tip portion is thicker than each root portion. Because of such a configuration, the user can join the massage units 66a, 66b by moving them in a vertical direction under the condition that positions of each projection 88 and each associated recess 90 coincide with one another in this direction. Once the massage units 66a, 66b are mated, those units 66a, 66b cannot be separated by being moved in a horizontal direction. The massage units 66a, 66b, however, can be easily separated by moving them in the vertical direction.

The user can simultaneously massage both soles 58a, 60a by using the sole massage device 66. That is, as shown in FIG. 9, the user sits on a chair or seat and moves his or her right foot 58 and left foot 60 alternately or together back and force over the rollers 34. Thus, the stiffness can be taken out of both the soles 58a, 60a and/or the circulation of the blood can be improved. The magnetic force of the magnet 44 can of course expedite the effect also in this embodiment.

In addition to the convenient use described above, each massage unit 66a, 66b is compact enough to be placed in a suitcase or a dress pocket when the units 66a, 66b are separated.

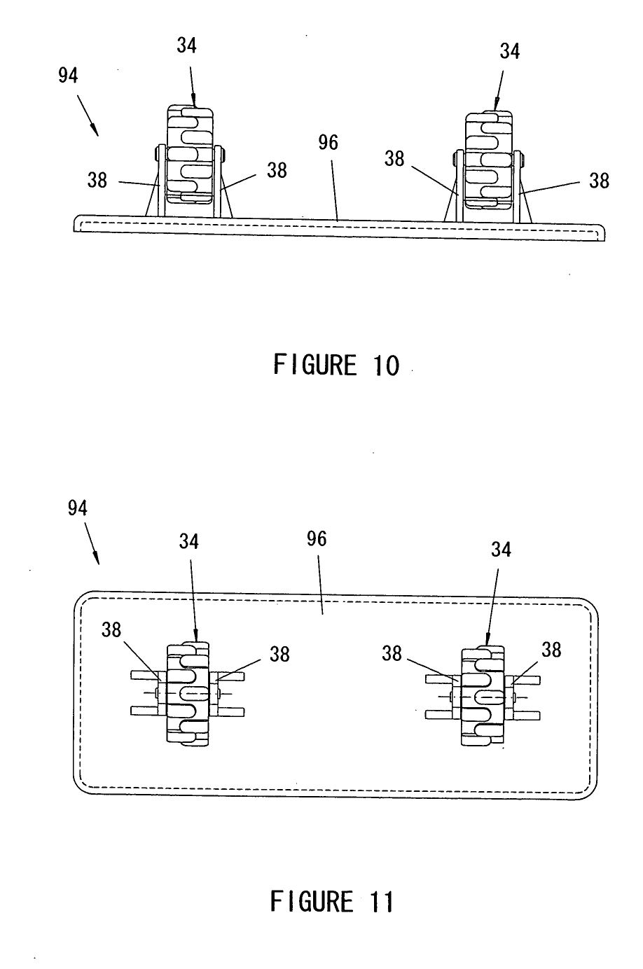

With reference to FIGS. 10 and 11, a further sole massage device 94 modified in accordance with a third embodiment is described. Because the construction and arrangement of the massage device 94 is similar to the massage device 66, the same members and components are assigned with the same reference numerals and are not described repeatedly.

In this embodiment, a relatively large base 96 replaces the bases 70 in the second embodiment. The illustrated base 96 is generally rectangularly shaped in a top plan view. Various shaped, however, can be applied for the base 96. For example, an oval shape or an irregular shape such that a mid portion is narrowed are applicable. A pair of rollers 34 are placed on the base 96 side by side and are rotatably supported by the posts 38. The base 96 is made of plastic or metal.

In some arrangements, the base 96 can be divided into two sections such that each section has each roller 34, and both the sections can be connected to each other by one or more hinges. This construction is useful because the user can use the massage device 94 for simultaneously massaging both the soles and also the user can fold over the sections to carry the device 94. In one variation, the base 96 can be made of a relatively soft plastic material so as to be turned down for the easy carry.

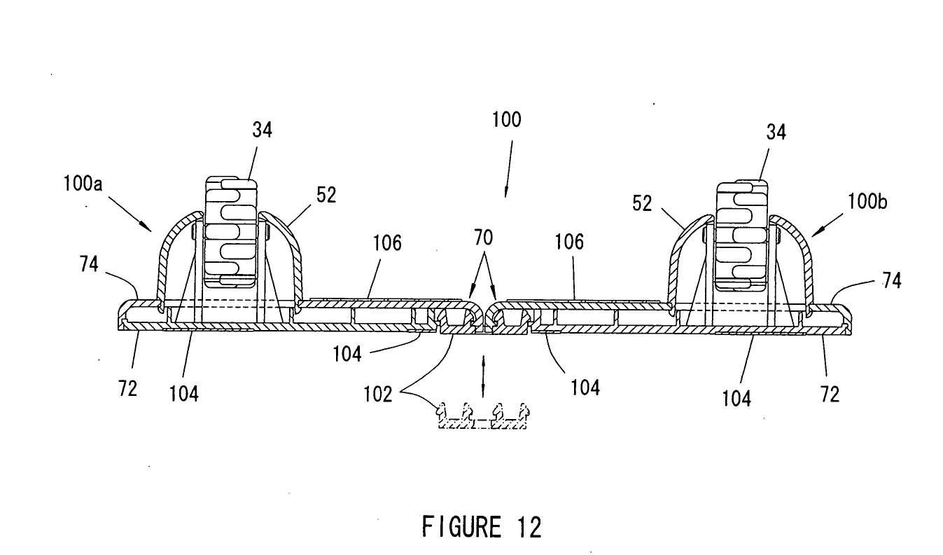

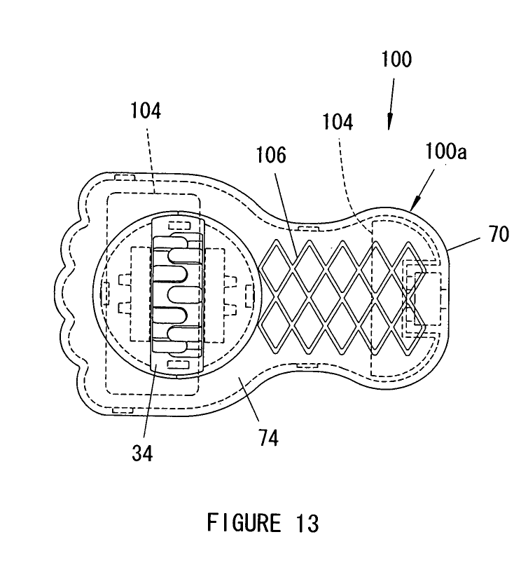

With reference to FIGS. 12 and 13, a further sole massage device 100 modified in accordance with a fourth embodiment is described. Because the construction and arrangement of the massage device 100 is similar to the massage device 66, the same members and components are assigned with the same reference numerals and are not described repeatedly.

The massage device 100 in this embodiment comprises a pair of massage units 100a, 100b. Those units 100a, 100b are detachably coupled by one or more plastic couplers 102 which are separable from the units 100a, 100b. The illustrated couplers 102 can be snapped into the position to connect the massage units 100a, 100b. Each coupler 100a, 100b has a bottom surface that can make a flush surface with the bottom surfaces of the bottom members 72 when the couplers 102 are attached thereto. Other types of couplers can be used to couple the separated units 100a, 100b.

In this embodiment, two slippage stoppers 104 are attached to the bottom surfaces of the units 100a, 100b to prevent the massage device 100 from slipping off. The illustrated stoppers 104 occupy relatively large area to increase the slippage stop effect. The stoppers 104 preferably are made of rubber. Also, a slippage stopper pattern 106 preferably is formed on a top surface of each top member 74 to prevent the user or another person from slipping on the surfaces. Preferably, the stopper pattern 106 can be unitarily made as a relief when each top member 74 is produced. A grid pattern is preferably used in this embodiment, although any other patterns can be used.

A test that the inventor made using the sole massage device 100 showed a result such that the blood flow velocity increased by approximately 1.6 times and the blood flow amount also increased by approximately 1.5 times. The testee is a healthy adult woman (32 years old). First, the blood flow velocity BFV1 and the blood flow amount BFA1 were measured using a laser Doppler blood flowmeter after she stayed in rest for ten minutes on a chair. Fourteen data were taken with regard to each subject BFV1, BFA1 within 20 minutes and each average is calculated. Then, she used the massage device 100 ten minutes later. Afterwards, the blood flow velocity BFV2 and the blood flow amount BFA2 were measured using the same laser Doppler blood flowmeter. Fourteen data were taken with regard to each subject BFV2, BFA2 within 20 minutes and each average is calculated. The averages were compared with the corresponding averages to calculate the foregoing result (i.e., BFV2=1.6*BFV1 and BFA2=1.5*BFA1).

In some variations, the shaft can be affixed to the posts under the condition that the roller with the magnet can rotate relative to the shaft.

Although this invention has been disclosed in the context of a certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described, other modifications, which are within the scope of this invention, will be readily apparent to those of skill in the art based upon this disclosure. It is also contemplated that various combination or sub-combinations of the specific features and aspects of the embodiments or variations may be made and still fall within the scope of the invention. It should be understood that various features and aspects of the disclosed embodiments can be combined with or substituted for one another. Thus, it is intended that the scope of the present invention herein disclosed should not be limited by the particular disclosed embodiments described above, but should be determined only by a fair reading of the claims.

1. A sole massage device comprising a roller adapted to contact a sole, and a base arranged to rotatably support the roller.

2. The sole massage device as set forth in claim 1, wherein the base comprises a first portion extending generally horizontally, and a second portion extending generally vertically from the first portion, the second portion supports the roller.

3. The sole massage device as set forth in claim 2, wherein the second portion comprises a pair of posts, the roller is interposed between the posts.

4. The sole massage device as set forth in claim 3, wherein the roller has a shaft rotatably supported by the posts.

5. The sole massage device as set forth in claim 2, wherein the roller has a shaft rotatably supported by the second portion.

6. The sole massage device as set forth in claim 2, wherein the first portion comprises a protruded portion next to the second portion, the protruded portion is adapted to be held by the other sole.

7. The sole massage device as set forth in claim 1, wherein the roller comprises a roller body and a magnet.

8. The sole massage device as set forth in claim 7, wherein the roller body encloses the magnet.

9. The sole massage device as set forth in claim 7, wherein magnetic poles of the magnet are disposed circumferentially.

10. The sole massage device as set forth in claim 7, wherein the roller body has an uneven surface.

11. The sole massage device as set forth in claim 10, wherein a plurality of projections form the uneven surface.

12. The sole massage device as set forth in claim 1, wherein the roller has a plurality of projections disposed on a circumferential surface thereof.

13. A sole massage device comprising first and second rollers each adapted to contact each sole of a human body, and a base arranged to rotatably support the rollers.

14. The sole massage device as set forth in claim 13, wherein the base comprises first and second sections separably coupled with each other, the first section supports the first roller, and the second section supports the second roller.

15. The sole massage device as set forth in claim 11, wherein the base comprises first and second sections coupled with each other by a hinge coupling, the first section supports the first roller, and the second section supports the second roller.

16. A sole massage device comprising a rotary member having a plurality of projections on a surface thereof, a support member arranged to support the rotary member, and a horizontal member extending generally horizontally, the support member extending upward from the horizontal member.

17. The sole massage device as set forth in claim 16, wherein the rotary member incorporates a magnet.
